(19) United States
(12) Patent Application Publication
(10) Pub. No.: US 2026/0213785 A1
(43) Pub. Date: Jul. 23, 2026

(54) NFC TYPE A DEVICE IN CONFIGURABLE LOGIC BLOCK

(71) Applicant: Microchip Technology Inc., Chandler, AZ (US)

(72) Inventor: Valentin Stoia, Bucuresti (RO)

(73) Assignee: Microchip Technology Inc., Chandler, AZ (US)

(21) Appl. No.: 19/235,656

(22) Filed: Jun. 12, 2025

Related U.S. Application Data
(60) Provisional application No. 63/748,920, filed on Jan. 23, 2025.

(51) Int. Cl. H04B 5/20; H04B 5/70

(52) U.S. Cl. CPC H04B 5/20; H04B 5/70

(57) ABSTRACT

Systems and methods are provided for receiving, decoding, encoding, and transmitting signals for an NFC Type A device using a configurable logic block (CLB) to receive a data signal, generate a start signal indicating that a start bit has been detected, generate a data high signal indicating that a logic high value has been detected, generate a data sample signal indicating a sampling time for the receive data signal, generate an end of data signal indicating that an end of the receive data signal has been detected, and generate a transmit data signal. The systems and methods may include instructions executed by a microprocessor to use the CLB-generated signals to process the receive data signal and to transmit data.

### PRIORITY

This application claims priority to commonly owned U.S. Patent Application No. 63/748,920 filed Jan. 23, 2025, the entire contents of which are hereby incorporated by reference for all purposes.

### FIELD OF THE INVENTION

The present disclosure relates to near-field communication (NFC) systems and methods. Various examples of the teachings herein include systems and/or methods for receiving, decoding, encoding, and transmitting signals for an NFC Type A device using a configurable logic block (CLB).

### BACKGROUND

The ISO1444-3 standard defines the NFC Type A device and its communication protocol(s). For example, the communication from an NFC reader (e.g., PCD) to an NFC card (e.g., RFID, PICC) for an NFC Type A device utilizes a modified Miller encoding, whereas the communication from an NFC card to the NFC reader (Type A) utilizes a Manchester encoding (over a frequency subcarrier).

NFC Type A devices may be implemented in dedicated hardware (e.g., standalone RFID chips) or as IP modules for integration onto an integrated circuit. These approaches can be expensive due to IP licensing costs, validation of hardware/modules, and additional communication latency (e.g., when using dedicated hardware), among others.

The present disclosure may avoid or reduce these drawbacks by providing NFC Type A communication using a CLB designed to work in conjunction with a small set of embedded C-code. In an example, the present disclosure may be implemented in the CLB found on the PIC16F13145 microcontroller sold by the assignee of the present disclosure (Microchip Technology Incorporated). In an example, the CLB may provide the basis for both Type A signal decoding and encoding. In this manner, the NFC Type A communication may be achieved with the PIC16F13145 microcontroller (as device/card/slave) with minimal use of the microcontroller's available hardware resources.

### SUMMARY

The examples herein enable systems and methods for receiving, decoding, encoding, and transmitting signals for an NFC Type A device using a CLB.

According to one example, an apparatus is provided that includes a microprocessor and a configurable logic block that may be configured to receive a receive data signal for a near-field communication Type A device; generate a start signal indicating that a start bit has been detected in the receive data signal for the near-field communication Type A device; generate a data high signal indicating that a logic high value has been detected in the receive data signal for the near-field communication Type A device; generate a data sample signal indicating a sampling time for the receive data signal for the near-field communication Type A device; and generate an end of data signal indicating that an end of the receive data signal has been detected. In an example, the configurable logic block configured to generate the start signal may include logic configured to detect a 1-0-1-1-1 binary pattern in the receive data signal for the near-field communication Type A device. In the same or different examples, the configurable logic block configured to generate the data sample signal may include logic configured to detect a 1-1-0-1 binary pattern in the receive data signal for the near-field communication Type A device. In the same or different examples, the configurable logic block configured to generate the end of data signal may include logic configured to detect a 1-1-1-1-1-1-1-1 binary pattern in the receive data signal for the near-field communication Type A device.

In the same or different examples, the apparatus may include instructions, executable by the microprocessor, to use the start signal, the data high signal, the data sample signal, and the end of data signal to process the receive data signal for the near-field communication Type A device. In an example, the instructions to process the receive data signal may include instructions, executable by the microprocessor, to determine that a logic one is received in the receive data signal when the data sample signal is valid and the data high signal is enabled; and determine that a logic zero is received in the receive data signal when the data sample signal is valid and the data high signal is not enabled.

In the same or different examples, the apparatus may include a transmit delay counter and the configurable logic block may be configured to generate a transmit timer trigger based on the end of data signal and the data sample signal, the transmit timer trigger causing the transmit delay counter to start; and in response to the transmit delay counter reaching a predetermined delay count, generate a transmit data signal for the near-field communication Type A device.

In the same or different example, the apparatus may include a first clock generator circuit configured to generate a first clock signal having a first frequency; a second clock generator circuit configured to generate a second clock signal having a second frequency; and instructions, executable by the microprocessor, to cause the configurable logic block to use the first clock signal when receiving the receive data signal, and to use the second clock signal when generating the transmit data signal for the near-field communication Type A device. In an example, the configurable logic block configured to generate the transmit data signal for the near-field communication Type A device may include logic configured to use the first clock signal, the second clock signal, and a data value input to generate a bit of data for the transmit data signal; and the second frequency may correspond to a divided value of the first frequency.

According to another example, a apparatus is provided that includes a microprocessor; a receive data input signal for receiving input data encoded according to a Modified Miller encoding scheme for a near-field communication Type A device; a transmit data output signal for transmitting output data encoded according to a Manchester encoding scheme for the near-field communication Type A device; a transmit delay counter; a configurable logic block having an input clock signal, a plurality of sequential logic elements coupled to the input clock signal, and a plurality of combinational logic elements, wherein the plurality of sequential logic elements and the plurality of combinational logic elements operable to be configured; and a non-volatile memory having a plurality of instructions stored therein. In an example the plurality of instructions may be executable by the microprocessor to configure the plurality of sequential logic elements and the plurality of combinational logic elements in the configurable logic block to: generate a start signal indicating that a start bit for the near-field communication Type A device has been detected in the receive data input signal; generate a data high signal indicating that a logic high value for the near-field communication Type A device has been detected in the receive data input signal; generate a data termination signal indicating that an end of transmission for the near-field communication Type A device has been detected in the receive data input signal; generate a data sample signal indicating a sampling time for the receive data input signal; generate a transmit timer trigger indicating to start the transmit delay counter; and generate the encoded transmit data output signal based on a plurality of data output values. The plurality of instructions may also be executable by the microprocessor to use the start signal, the data high signal, the data sample signal, and the data termination signal to decode the encoded receive data input signal; and provide the configurable logic block with the plurality of data output values after the transmit delay counter reaches a predetermined delay count. In the same or different examples, the configurable logic block may include a plurality of lookup tables, and wherein the configuring the plurality of sequential logic elements and the plurality of combinational logic elements in the configurable logic block may use fewer than 32 lookup tables of the plurality of lookup tables.

In the same or different examples, the plurality of instructions executable by the microprocessor to change a frequency of the input clock signal of the configurable logic block. In an example, the instructions may include instructions to couple the input clock signal of the configurable logic block to a first clock signal when receiving the input data on the receive data input signal; and couple the input clock signal of the configurable logic block to a second clock signal when generating the encoded transmit data output signal.

Another example provides a method which may include receiving, by an electronic device having a configurable logic block, a receive data signal for a near-field communication Type A device. The method may include generating, in the configurable logic block, a start signal indicating that a start bit has been detected in the receive data signal for the near-field communication Type A device. The method may include generating, in the configurable logic block, a data high signal indicating that a logic high value has been detected in the receive data signal for the near-field communication Type A device. The method may include generating, in the configurable logic block, a data sample signal indicating a sampling time for the receive data signal for the near-field communication Type A device. The method may include generating, in the configurable logic block, an end of data signal indicating that an end of the receive data signal has been detected.

In the same or different examples, the method may include executing, by a microprocessor in the electronic device, instructions to use the start signal, the data high signal, the data sample signal, and the end of data signal to process the receive data signal for the near-field communication Type A device.

In the same or different examples, the method may include generating, in the configurable logic block, a transmit timer trigger based on the end of data signal and the data sample signal, the transmit timer trigger indicating to start a transmit delay counter in the electronic device; and in response to the transmit delay counter reaching a predetermined delay count, generating, in the configurable logic block, a transmit data signal for the near-field communication Type A device. In some examples, the generating the transmit data signal for the near-field communication Type A device may include using a first clock, a second clock, and a data value input to generate a bit of data for the transmit data signal, the second clock having a frequency corresponding to a divided value of a first frequency of the first clock.

In the same or different examples, the method may include executing, by a microprocessor in the electronic device, instructions to provide a plurality of data values to the configurable logic block, the configurable logic block using the plurality of data values to generate the transmit data signal for the near-field communication Type A device.

In the same or different examples, the method may include executing, by a microprocessor in the electronic device, instructions to change a frequency of a clock signal used by the configurable logic block, the changing of the frequency occurring (i) after the receiving the receive data signal and (ii) prior to the generating the transmit data signal for the near-field communication Type A device.

### BRIEF DESCRIPTION OF THE DRAWINGS

The figures illustrate example systems and methods for receiving, decoding, encoding, and transmitting signals for an NFC Type A device using a CLB.

FIG. 1 illustrates a block diagram of an example apparatus for receiving and decoding signals for an NFC Type A device using a CLB.

FIG. 2 illustrates a block diagram of an example apparatus for receiving and decoding signals for an NFC Type A device using a CLB.

FIG. 3 illustrates a block diagram of an example apparatus for receiving, decoding, encoding, and transmitting signals for an NFC Type A device using a CLB.

FIG. 4 illustrates a block diagram of an example apparatus for receiving, decoding, encoding, and transmitting signals for an NFC Type A device using a CLB.

FIG. 5 illustrates a block diagram of an example apparatus for receiving, decoding, encoding, and transmitting signals for an NFC Type A device using a CLB.

FIG. 6 illustrates a block diagram of an example apparatus for receiving, decoding, encoding, and transmitting signals for an NFC Type A device using a CLB.

FIG. 7 illustrates an example CLB for receiving, decoding, encoding, and transmitting signals for an NFC Type A device.

FIG. 8 illustrates an example start bit timing according to a “modified Miller” encoding.

FIG. 9 illustrates an example receive data sample timing according to NFC Type A device.

FIG. 10 illustrates an example transmit data delay timing according to NFC Type A device.

FIG. 11 illustrates an example Manchester encoding for NFC Type A transmission (device to reader) according to the present disclosure.

FIG. 12 illustrates an example divide-by-8 clock circuit according to the present disclosure.

FIG. 13 illustrates an example timing diagram with various indicators that may be generated by a CLB according to the present disclosure.

FIG. 14 illustrates an example timing diagram of the signals of a CLB that may be involved in transmitting data according to the present disclosure.

FIG. 15 illustrates an example implementation of an NFC Type A device circuit according to the present disclosure using the PIC16F13145 microcontroller by assignee, Microchip Technology Corporation.

FIG. 16 illustrates a flow chart of an example method for receiving and decoding signals for an NFC Type A device in an electronic device having a configurable logic block.

FIG. 17 illustrates a flow chart of an example method for receiving and decoding signals for an NFC Type A device in an electronic device having a configurable logic block.

FIG. 18 illustrates a flow chart of an example method for receiving, decoding, encoding, and transmitting signals for an NFC Type A device having a configurable logic block.

FIG. 19 illustrates a flow chart of an example method for receiving, decoding, encoding, and transmitting signals for an NFC Type A device having a configurable logic block.

FIG. 20 illustrates a flow chart of an example method for receiving, decoding, encoding, and transmitting signals for an NFC Type A device having a configurable logic block.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The following description sets forth examples of the present disclosure. It should be recognized, however, that such description is not intended as a limitation on the scope of the present disclosure. Rather, the description also encompasses combinations and modifications to the examples described herein.

The teachings of the present disclosure may be employed to provide a custom CLB circuit that provides to the microcontroller (MCU) the basis for both NFC Type A signal decoding and encoding (ISO1444-3), while setting flags to allow C-code to poll for (1) NFC data reception, (2) NFC data transmission, and (3) automated time synchronization between reception and transmission (as required by the ISO1444-3). In this manner, an MCU may achieve full NFC Type A communication by running a program that polls the flags set by the CLB, and uses those flags to retrieve data and provide data to the CLB for transmission, resulting in an overall embedded resource consumption (e.g., memory and peripherals) that is low and that allows for full user customization, e.g., for an RFID tag's UUID.

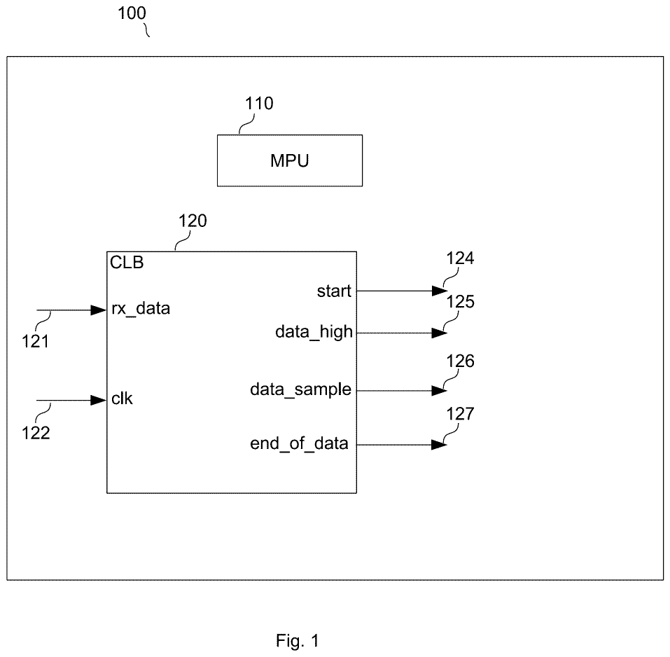

FIG. 1 illustrates an example apparatus 100 for receiving and decoding signals for an NFC Type A device using a CLB. Apparatus 100 may include microprocessor unit (MPU) 110 and CLB 120. MPU 110 may be of any suitable type. It may include, for example, a general-purpose microprocessor, a digital signal processor (DSP), a microcontroller, or a specialized processing unit such as a system-on-chip (SoC) or application-specific integrated circuit (ASIC).

MPU 110 may comprise a single core or multiple cores, and may be implemented using any appropriate instruction set architecture, including but not limited to MIPS (e.g., MIPS32), x86, ARM, or RISC-V, or MIPS. Furthermore, MPU 110 may be configured to execute instructions stored in memory, perform logical operations, control peripheral devices (e.g., CLB, among other), or interface with other components of the apparatus 100. The particular choice of MPU may depend on performance, power, cost, or integration considerations and does not limit the scope of the present disclosure.

CLB 120 may include rx_data input 121 and clk input 122. In an example, rx_data input 121 may be a binary (digital) signal that may be based on receiving NFC data via a conventional NFC antenna (resonating circuit) (not illustrated). In the same or different examples, the received NFC data may be processed by an NFC (RX) envelope detector and low-pass filter (also not illustrated) before being provided to CLB 120 as rx_data input 121. In the same or different examples, rx_data input 121 may be encoded with a “modified Miller” encoding according to the ISO14443-3 specification.

In an example, clk input 122 may be a clock signal with a frequency that may match the ‘quartered bit’ timing of the ISO1444-3 specification, i.e., ((13.56 MHz/128)*4) or 423.75 kHz. In examples, the frequency of clk input 122 may vary depending on whether CLB 120 is receiving NFC Type A data or transmitting NFC Type A data. For example, clk input 122 may have a 423.75 kHz frequency for receiving NFC data (2.36 μs period) and may have a frequency fast enough to support transmitting NFC data with a ((13.56 MHz/128)*8) or 847.5 kHz carrier frequency (1.18 μs period).

CLB 120 may provide programmable logic that operates outside the speed limitations of software executing on MPU 110. CLB 120 may take a number of input signals and, through the use of configurable gates, may reduce the input signals into logic lines that may drive selectable single-output logic functions. In an example, input sources to CLB 120 may be one or more of the following: I/O pins of a microcontroller, internal clocks of a microcontroller, peripheral outputs, register bits, and software, without limitation. CLB 120 outputs may be directed internally to one or more peripherals and output pins of the microcontroller. CLB 120 may be configured to include combinatorial logic (e.g., AND, NAND, AND-OR, AND-OR-INVERT, OR-XOR, OR-XNOR, buffer, inverting buffer, multiplexer, n-input LUT, without limitation) and latches (e.g., S-R, clocked D with Set and Reset, transparent D with Set and Reset, clocked J-K with Reset, without limitation), In an example, CLB 120 may be configured through software, for example, by writing configuration information to registers in CLB 120. Once these registers are set up, CLB 120 may run independently of software control until the registers are changed via software.

In operation, CLB 120 may generate start signal 124, data_high signal 125, data_sample signal 126, and end_of_data signal 127. In an example, signals 124-127 may be provided as outputs of CLB 120. In another example, signals 124-127 may be stored in program-accessible registers within CLB 120. Start signal 124 may indicate a start bit has been detected on rx_data input 121. Data_high signal 125 may indicate a logic value “1” has been detected on rx_data input 121. Data_sample signal 126 may indicate that data_high signal 125 is valid and may be sampled. In an example, if data_high signal 125 indicates a logic value “1” has been detected when data_sample signal 126 is active, it may be determined that a logic value “1” has been received on the rx_data input 121. In the same example, if data_high signal 125 does not indicate a logic value “1” has been detected when data_sample signal 126 is active, it may be determined that a logic value “0” has been received on the rx_data input 121. End_of_data signal 127 may indicate that the end of transmission has been detected on rx_data input 121. Each of signals 124-127 may be binary signals that may be either active high or active low indicators.

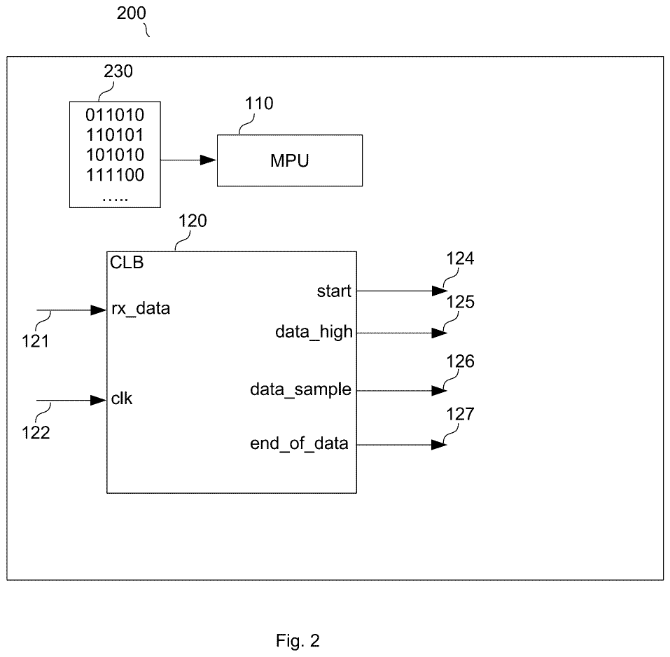

FIG. 2 illustrates an example apparatus 200 for receiving and decoding signals for an NFC Type A device using a CLB. Apparatus 200 in FIG. 2 is similar to apparatus 100 in FIG. 1 and may additionally include instructions 230 which, when executed by MPU 110, may use start signal 124, data_high signal 125, data_sample signal 126, and end_of_data signal 127 to process rx_data input 121 for the NFC Type A device.

In operation, instructions 230 may implement the following pseudo-code for receiving NFC Type A device data:

```
while(1) {
  wait_for_clb_start_to_assert( );
  while(!clb_end_of_data) {
    wait_for_clb_data_sample_to_assert( );
    next_rx_data_bit = clb_data_high;
  }
}
```

In the given example, instructions 230 may first wait for start signal 124 to assert (i.e., wait_for_clb_start_to_assert( )), indicating a start bit has been detected on rx_data input 121. In the example, waiting for the start bit may be done in a continuous while(1) loop. In other examples, start signal 124 may be associated with a system interrupt so that an interrupt handler may execute the remaining pseudocode when start signal 124 asserts. Other means of waiting for start signal 124 to assert (e.g., polling a status bit, among others) are within the scope of the present disclosure. Following an assertion of the start bit, instructions 230 may then wait for data_sample signal 126 to assert (i.e., wait_for_clb_data_sample_to_assert( )), at which time data_high signal 125 may be sampled as the next bit of rx_data input 121. Waiting for data_sample signal 126 to assert may be implemented via interrupt/interrupt handler, polling, or other similar means. In an example, instructions 230 may continue in this manner (e.g., sampling data_high signal 125 when data_sample signal 126 is asserted) until end_of_data signal 127 asserts (i.e., clb_end_of_data), indicating the end of receive data on rx_data input 121.

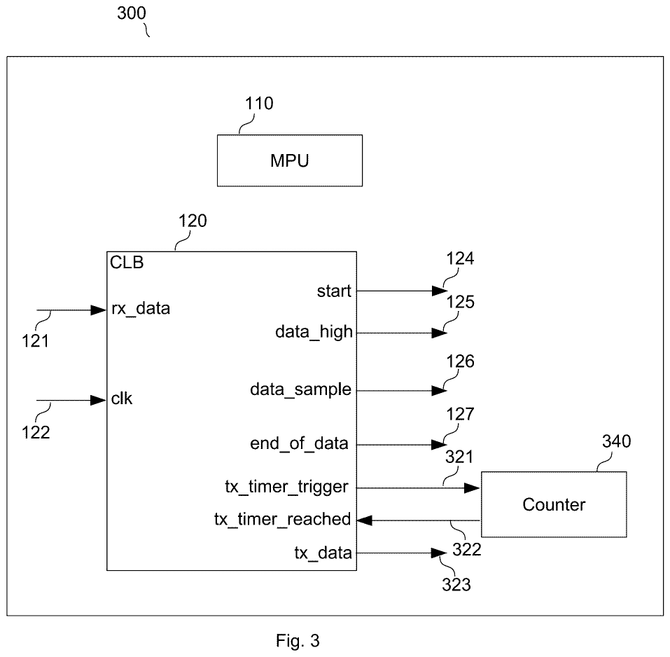

FIG. 3 illustrates an example apparatus 300 for receiving, decoding, encoding, and transmitting signals for an NFC Type A device using CLB 120. Apparatus 300 in FIG. 2 is similar to apparatus 100 in FIG. 1 and may additionally include tx_timer_trigger signal 321, tx_timer_reached signal 322, tx_data signal 323, and counter 340.

In an example, counter 340 may be a digital counter configured to incrementally track the number of events occurring over time. For example, each incoming pulse or triggering signal (e.g., a rising edge of a clock input (not depicted)) may cause the counter to increment its stored value by one. In an example, counter 340 may be implemented in a timer peripheral. In examples, counter 340 may support reset functionality, allowing its value to be cleared upon receiving a reset signal, and may also include a clock input to synchronize counting operations with a system clock. In some examples, counter 340 may be programmable to count in binary, binary-coded decimal (BCD), or other formats, and may include overflow detection logic to flag when a maximum count value is reached. In examples, the current count value may be stored in program-accessible registers, output to other digital logic, or stored in memory for further processing.

In operation, CLB 120 may generate tx_timer_trigger signal 321 and tx_data signal 323. In an example, signals 321 and 323 may be provided as outputs of CLB 120. In another example, signals 321 and 323 may be stored in program-accessible registers within CLB 120.

For many basic transaction types, ISO1444-3 imposes an exact time for a Type A device (e.g., NFC card/RFID) to respond to a message from the reader, which time depends on the value of the last parity bit. In order to satisfy the specified delay between receiving a message and transmitting a response, CLB 120 may generate tx_timer_trigger signal 321 which, when asserted, may cause counter 340 to begin counting a predetermined number of clock cycles (i.e., corresponding to the delay specified by the ISO1444-3 specification). In an example, the predetermined number of clock cycles may correspond to a count value programmed into counter 340 based on the clock frequency used by counter 340 and the delay specified by the ISO1444-3 specification. In an example, CLB 120 may generate an assertion of tx_timer_trigger signal 321 when both end_of_data signal 127 and data_sample signal 126 are both asserted. When this condition is met, tx_timer_trigger signal 321 may assert and cause counter 340 to begin counting. When counter 340 has reached the predetermined delay (e.g., corresponding to the ISO1444-3 standard), it may assert tx_timer_reached signal 322 to indicate to logic in the CLB that data transmission may commence. In examples, following the assertion of tx_timer_reached signal 322, CLB 120 may begin generating tx_data signal 323 for serial transmission of response data. According to various examples, transmit data may be encoded according to a Manchester encoding for NFC Type A transmission (device to reader).

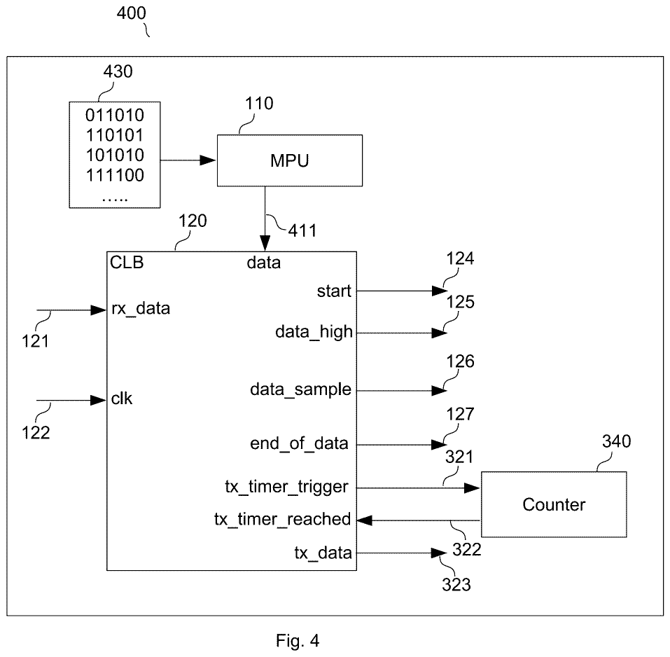

FIG. 4 illustrates an example apparatus 400 for receiving, decoding, encoding, and transmitting signals for an NFC Type A device using CLB 120. Apparatus 400 in FIG. 4 is similar to apparatus 300 in FIG. 3 and may additionally include instructions 430 which, when executed by MPU 110, may use start signal 124, data_high signal 125, data_sample signal 126, and end_of_data signal 127 to process rx_data input 121 for the NFC Type A device, as described for apparatus 200 of FIG. 2. In addition, apparatus 400 may additionally include data signal 411. Instructions 430 may cause MPU 110 to provide transmit data to CLB 120 via data signal 411. CLB 120 may additionally include tx_data signal 323, which may be a binary (digital) signal that is provided to a conventional NFC antenna (resonating circuit) (not illustrated) for transmitting data for the NFC Type A device.

In operation, instructions 430 may implement the following pseudo-code for transmitting NFC Type A device response data after receiving data from the reader:

```
wait_for_tx_timer_reached( );
while(is_data_to_transmit( )) {
  data = next_bit_of_data;
  wait_for_bit_transmission( );
}
```

In the given example, instructions 430 may first wait for tx_timer_reached signal 322 to assert (i.e., wait_for_tx_timer_reachedo), indicating that the delay required by ISO1444-3 before a Type A device (e.g., NFC card/RFID) may respond to a message from the reader has been met. Thereafter, while there is data to transmit to the reader (i.e., is_data_to_transmit( )), instructions 430 may cause data signal 411 to have the value of the next bit of data to transmit, wait for that bit of data to be transmitted (i.e., wait_for_bit_transmission( )), and continue until there is no more data to transmit. In an example, instructions 430 may track how many bits of data are to be transmitted and subtract the already-transmitted number of bits to determine how many bits remain to be transmitted. CLB 120 may forward data from data signal 411 to tx_data signal 323, which may be provided to a conventional NFC antenna (not illustrated) for transmission.

In an example, instructions 430 may additionally include the pseudo-code described above for FIG. 2, thus allowing for both receiving and transmitting data in an NFC Type A device. The following pseudo-code provides an example of receiving a data followed by transmitting response data in an NFC Type A device according to the present disclosure:

```
while(1) {
  wait_for_clb_start_to_assert( );
  while(!clb_end_of_data) {
    wait_for_clb_data_sample_to_assert( );
    next_rx_data_bit = clb_data_high;
  }
  start_tx_delay_timer( );
  wait_for_tx_timer_reached( );
  while(is_data_to_transmit( )) {
    data = next_bit_of_data;
    wait_for_bit_transmission( );
  }
}
```

In the given example, instructions 430 implement the receiving and transmitting data (via CLB 120) as previously described. In between receiving and transmitting, instructions 430 may start the transmit delay timer (i.e., start_tx_delay_timer( )), which may cause tx_timer_trigger_signal 321 to assert after the last data is received. In an example, starting the transmit delay counter may include resetting counter 340, setting the timer value in counter 340, or other operations to ensure counter 340 causes the tx_timer_reached signal 322 to assert after the delay required by ISO1444-3.

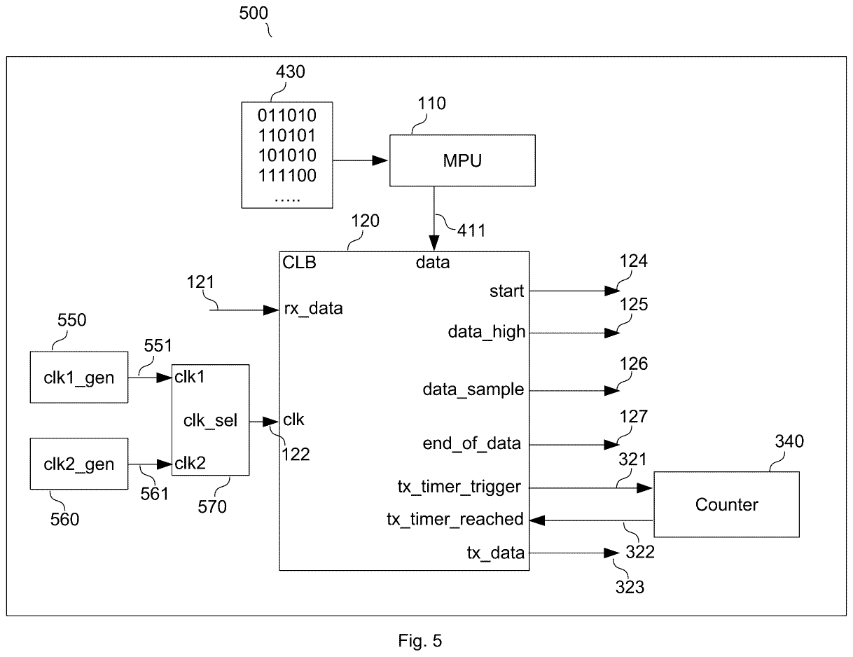

FIG. 5 illustrates an example apparatus 500 for receiving, decoding, encoding, and transmitting signals for an NFC Type A device using CLB 120. Apparatus 500 in FIG. 5 is similar to apparatus 400 in FIG. 4 and may additionally include clk1_gen 550, clk2_gen 560, and clk_sel circuit 570. Clk1_gen 550 and clk2_gen 560 may be clock generator circuits provided for generating a periodic clock signal at a specified frequency. For example, clk1_gen 550 may generate clk1 551 and clk2_gen 560 may generate clk2 561, where clk1 551 has a different frequency than clk2 561. The clock generators may include an oscillator circuit configured to produce a stable reference signal, and a frequency divider or phase-locked loop (PLL) circuit coupled to the oscillator to generate an output clock signal at the desired frequency. In some examples, the oscillator may be a crystal oscillator, a ring oscillator, or any other suitable timing source. The output frequency of clk1_gen 550 and clk2_gen 560 may be set based on fixed divider ratios, programmable control inputs, or feedback mechanisms within the PLL. In an example, clk_sel circuit 570 may select between clk1 and clk2, and the resulting clock signal may be used as the clock in CLB 120 (i.e., clk signal 122).

According to examples of the present disclosure, the receive and transmit clock frequencies may vary. In operation, clk2 561 may have a faster frequency than clk1 551. In an example, clk1 551 may be selected while CLB 120 is receiving data and clk2 561 may be selected while CLB 120 is transmitting data. In an example, instructions 230/430 may change the selection of the CLB clock (e.g., via clk_sel circuit 570) between data receiving and data transmission (and vice-versa). In an example, the clock frequency for data reception may match the ‘quartered bit’ timing according to the ISO1444-3 specification, or ((13.56 MHz/128)*4). In the same or different examples, the clock frequency for data transmission may be the highest frequency supported by apparatus 500 in order to be able to sample the clock-shaped signal at the frequency ((13.56 MHz/128)*8).

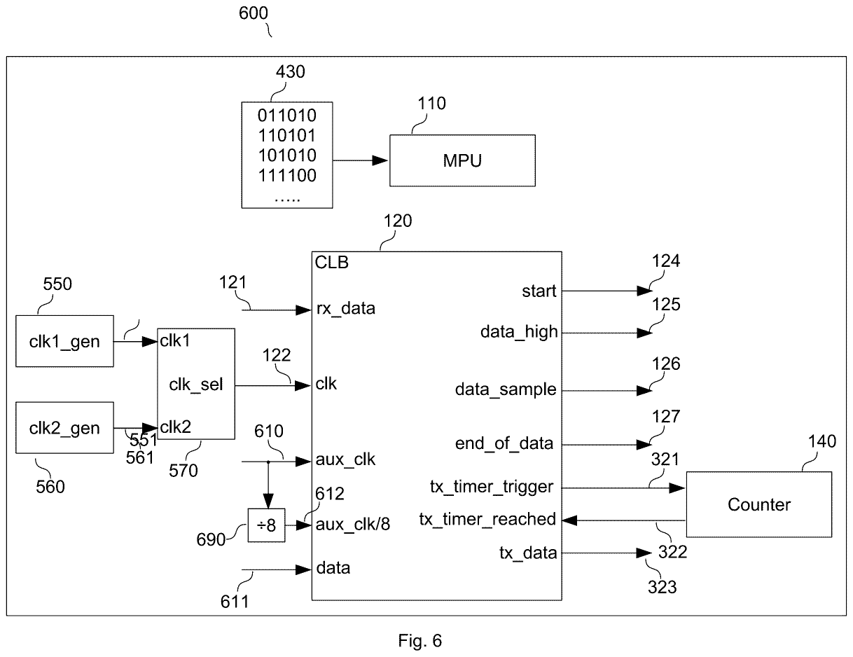

FIG. 6 illustrates an example apparatus 600 for receiving, decoding, encoding, and transmitting signals for an NFC Type A device using CLB 120. Apparatus 600 in FIG. 6 is similar to apparatus 500 in FIG. 5 and may additionally include CLB inputs aux_clk 610, aux_clk/8 612, and data 611. In the example, apparatus 600 may additionally include clock divider circuit 690 that may function to divide an input clock frequency by 8 to generate CLB input aux_clk/8 612. In addition, data signal 611 (input to CLB 120) in apparatus 600 may differ from data signal 411 in apparatus 500 in that it may be provided by MPU 110 or any other data source (e.g., a DMA, memory, other peripheral, among others).

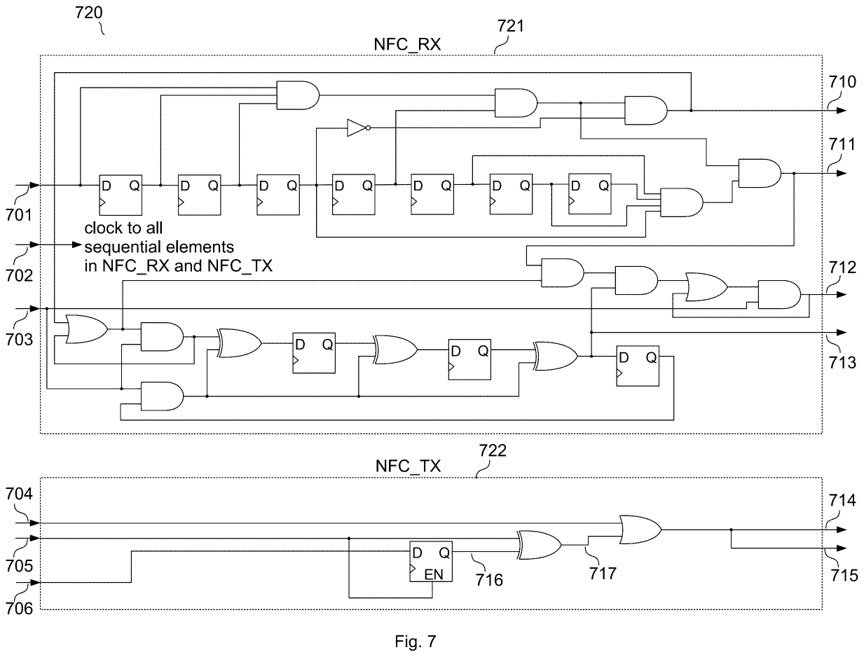

In operation, CLB 120 input aux_clk 610 may be a clock signal that may correspond to the auxiliary carrier frequency (847.5 kHz) for transmitting NFC Type A data. In the same or different examples, CLB 120 may use aux_clk input 610, aux_clk/8 input 612, and data input 611 to generate tx_data signal 323 according to a Manchester encoding for NFC Type A transmission (device to reader). An example of this is described in more detail for FIGS. 7 & 11.

FIG. 7 illustrates an example CLB 720 for receiving, decoding, encoding, and transmitting signals for an NFC Type A device. The illustrated example may use 30 lookup tables (LUTs) provided by a CLB module to implement the full NFC Type A device. CLB 720 may include NFC_RX logic 721 and NFC_TX logic 722. In an example, NFC_RX logic 721 may include rx_data input 701, clk input 702, rx_enable input 703, start_or_data_high signal 710, end_of_data signal 711, tx_timer_trigger signal 712, and data_sample signal 713. In the same or different examples, NFC_TX logic 722 may include clk input 702, aux_clk input 704, aux_clk/8 input 705, data input 706, tx_data signal 714, tx_data_tristate signal 715, data_reg signal 716, and xor_out signal 717.

Clk input 702 may be similar to clk input 122 in FIGS. 1-6. Rx_data input 701 may be similar to rx_data input 121 in FIGS. 1-6. Aux_clk input 704 and aux_clk/8 input 705 may be similar to aux_clk input 610 and aux_clk/8 input 612, respectively, in FIG. 6. Data input 706 may be similar to data input 611 (FIG. 6) and data input 411 (FIGS. 4-5). In an example data input 706 may be a manual data input (bit by bit) for transmitting data from the NFC Type A device.

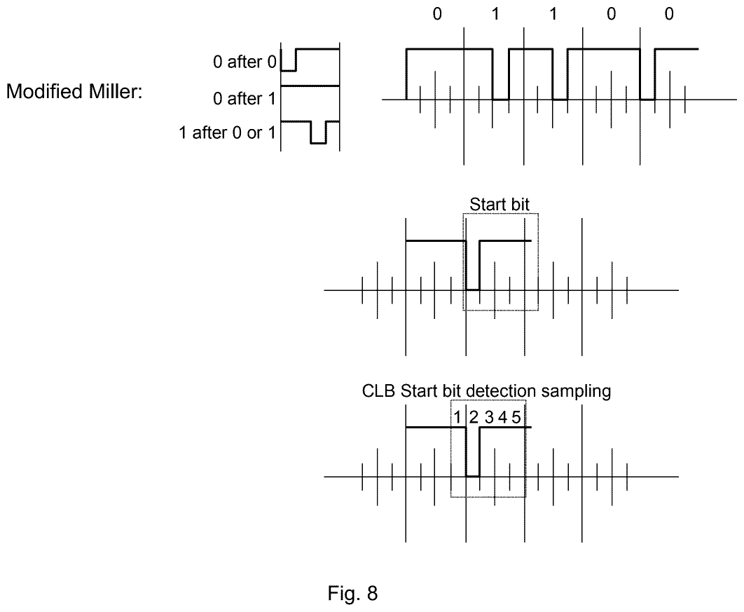

In the example, start_or_data_high signal 710 may combine the function of start signal 124 and data_high signal 125 in FIGS. 1-6. For example, it may be asserted when a start bit is detected on rx_data input 701 according to a “modified Miller” encoding. Logically, ISO14443-3 defines the start bit as a “Miller 0 after idle 0s” (see FIG. 8). In the illustrated example, the logic circuit (which may be implemented CLB 720/120) may sample 5 “bit quarters” to avoid false detections triggered by a simple low-to-high line transition. In this example, four cascaded D-flip-flops may be used with ANDing to identify the start bit detection pattern (e.g., when rx_data input 701 has a sequential pattern of “10111”).

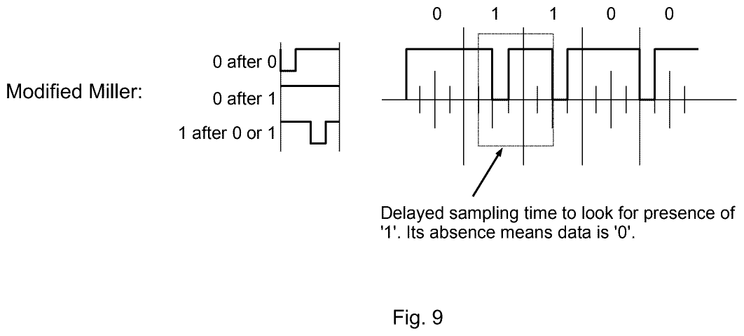

Following detection of a start bit and until end_of_data signal 711 asserts, start_or_data_high signal 710 may be sampled for data received by NFC_RX logic 721. For example, start_or_data_high signal 710, if asserted, may indicate a logic value of “1” is detected on rx_data input 701. When start_or_data_high signal 710 is not asserted, it may imply a logic value of “0” is detected on rx_data input 701. In an example, start_or_data_high signal 710 may be sampled for data when data_sample signal 713 is asserted (see FIG. 9).

In the FIG. 7 example, CLB 720 may generate data_sample signal 713 as a bit-quarter high pulse for every bit of received data on rx_data input 701. In the example, the data bit sampling indicator may be automatically triggered by the start bit detection (i.e. start_or_data_high signal 710 asserts). Data_sample signal 713 may be allowed or disabled manually by rx_enable input 703. In an example rx_enable input 703 is a register-bit-controlled input. According to the example, no logical “1” will be output unless the rx_enable input 703 is “1.” In the example data_sample signal 713 may continue to assert for each bit of received data on rx_data input 701 until rx_enable input 703 and start_or_data_high signal 710 are both 0.

In the FIG. 7 example, CLB 720 may generate end_of_data signal 711. In the illustrated example, seven cascaded D-flip-flops may be used to scan for eight consecutive high-level bit quarters in rx_data input 701 (i.e., when rx_data input 701 input pattern is “11111111”). The sampling moment may be provided by data_sample signal 713. As illustrated, various logic gates may be shared with the start bit detection circuit (i.e., logic for start_or_data_high signal 710), which may result in circuit footprint optimization.

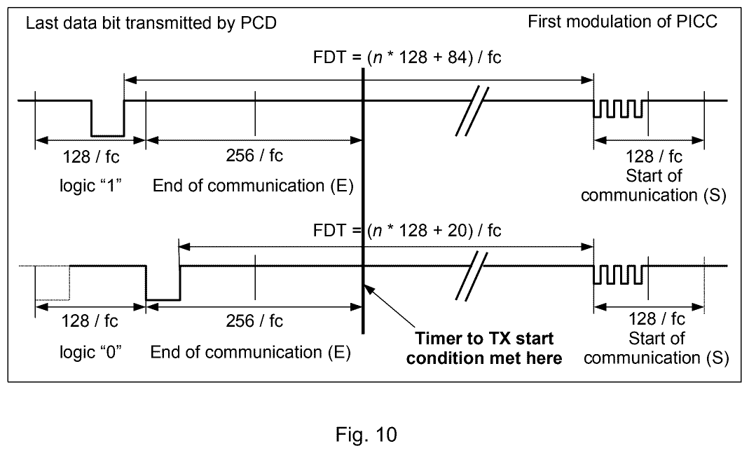

In the FIG. 7 example, CLB 720 may generate tx_timer_trigger signal 712 by ANDing end_of_data signal 711 with data_sample signal 713 and rx_enable input 703. CLB 720 may generate tx_timer_trigger signal 712 which, when asserted, may cause an external counter (e.g., counter 340 in FIG. 3) to begin counting a predetermined number of clock cycles (i.e., corresponding to the delay specified by the ISO1444-3 specification between receiving data and transmitting data for an NFC Type A device) (see FIG. 10).

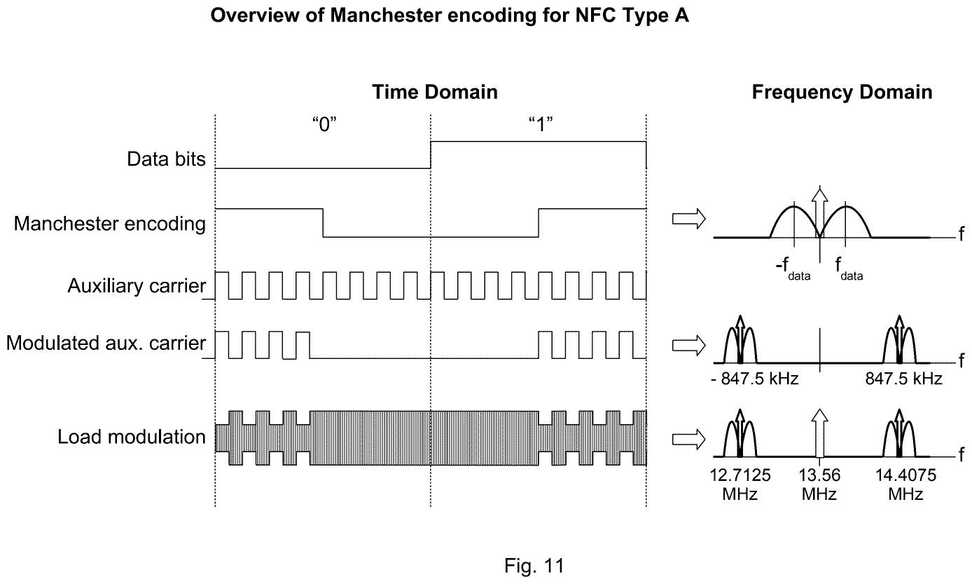

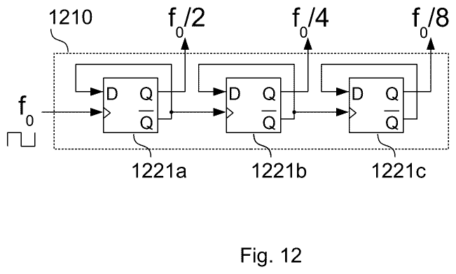

In the FIG. 7 example, CLB 720 may generate tx_data signal 714 and tx_data_tristate signal 715 for Manchester encoding of transmission data according to the present disclosure. (FIG. 11 illustrates an example Manchester encoding for NFC Type A transmission (device to reader) according to the present disclosure.) In the FIG. 7 example, the auxiliary carrier (aux_clk input 704) may start running when the counter started by the assertion of tx_timer_trigger signal 712 overflows. In an example, aux_clk/8 input 705 may be the auxiliary carrier frequency divided by 8. (FIG. 12 illustrates an example divide-by-8 clock circuit 1210 which may be implemented as three cascading D-flip-flops 1221a-c. In examples, the divide-by-8 clock circuit may be implemented in a configurable logic cell (CLC) peripheral.)

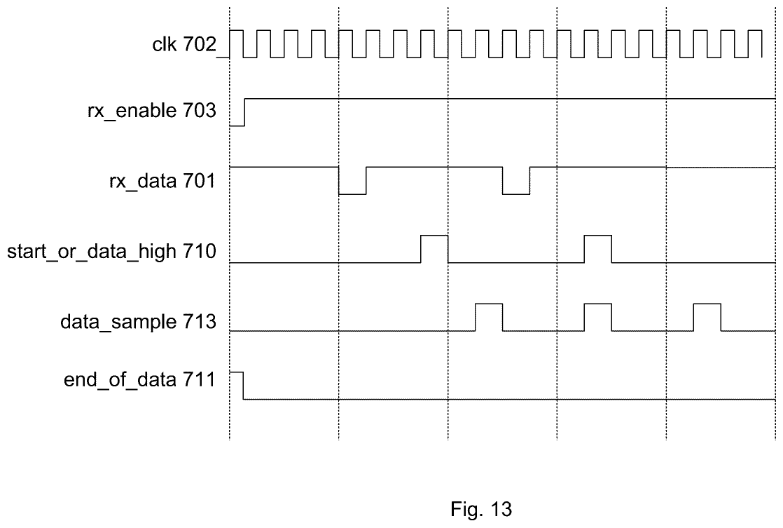

FIG. 13 illustrates an example timing diagram with various indicators that may be generated by CLB 720 according to the present disclosure.

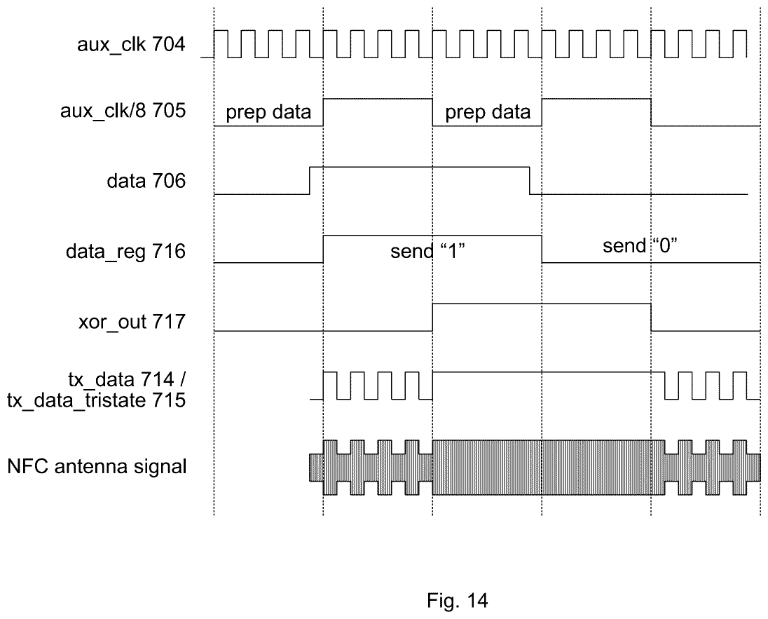

FIG. 14 illustrates an example timing diagram of the signals of CLB 720 that may be involved in transmitting data according to the present disclosure.

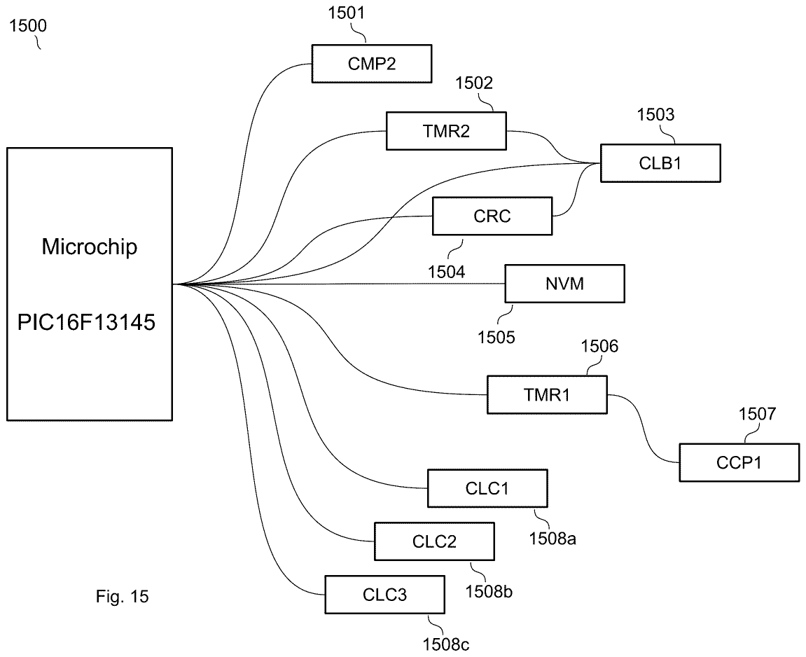

FIG. 15 illustrates an example implementation of an NFC Type A device circuit 1500 according to the present disclosure using the PIC16F13145 microcontroller by assignee, Microchip Technology Corporation. In an example, comparator OUT (CMP2 1501) may be used for generating the NFC rx_data digital logic signal (i.e., from the analog antenna input); timer2 (TMR2 1502) may be used to generate a reference clock for CLB1 1503; CRC 1504 and NVM 1505 may also be used by CLB1 1503; timer1 (TMR1 1506) may synchronize TX to RX and generate a base clock signal for TX with CCP1 1507; and CLCx modules 1508a-c (configured as D-flip-flops) may be cascaded to provide a 1:8 signal divider of CCP1 1507 for transmitting data (see FIG. 12). In some examples, one or more GPIOs may be allocated for CLB 1 1503 reference output signal access.

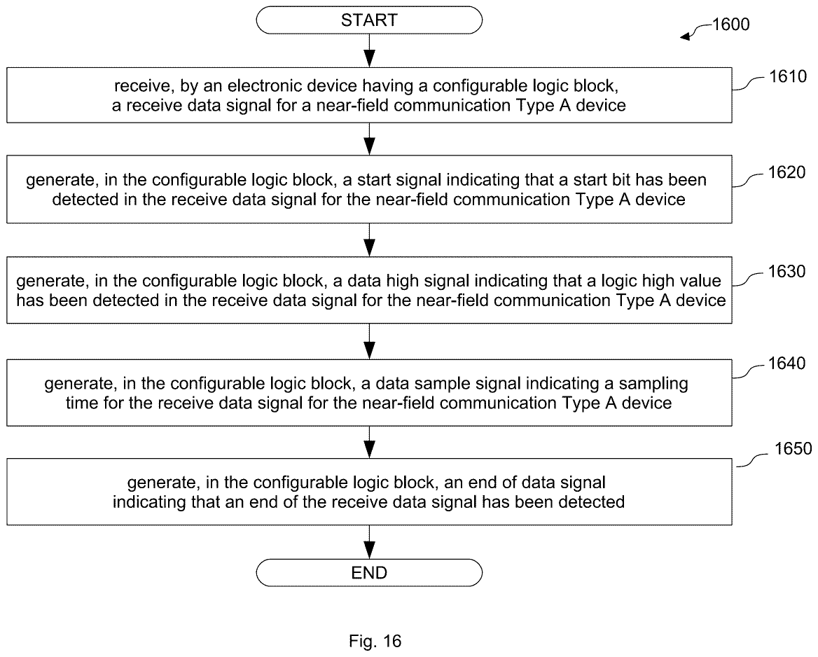

FIG. 16 illustrates a flow chart of an example method 1600 for receiving and decoding signals for an NFC Type A device in an electronic device having a configurable logic block. According to one example, method 1600 may begin at block 1610. Teachings of the present disclosure may be implemented in a variety of configurations of apparatus 100-600. As such, the initialization point for method 1600 and the order of 1610-1650 comprising method 1600 may depend on the implementation chosen.

At block 1610, an electronic device having a configurable logic block may receive a receive data signal for a near-field communication Type A device. At block 1620, the configurable logic block may generate a start signal indicating that a start bit has been detected in the receive data signal for the near-field communication Type A device. At block 1630, the configurable logic block may generate a data high signal indicating that a logic high value has been detected in the receive data signal for the near-field communication Type A device. At block 1640, the configurable logic block may generate a data sample signal indicating a sampling time for the receive data signal for the near-field communication Type A device. At block 1650, the configurable logic block may generate an end of data signal indicating that an end of the receive data signal has been detected.

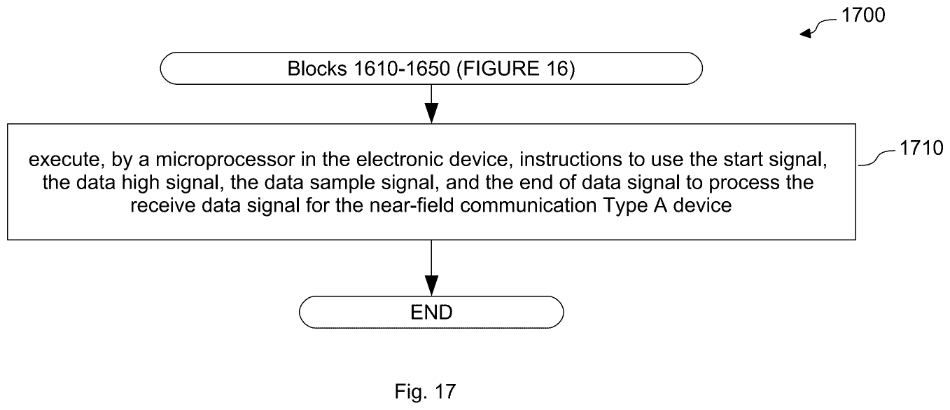

Although FIG. 16 discloses a particular number of operations related to method 1600, method 1600 may be executed with greater or fewer operations than those depicted in FIG. 16. For example, after block 1650, method 1600 may continue with additional operations illustrated in FIGS. 17-20. In addition, although FIG. 16 discloses a certain order of operations to be taken with respect to method 1600, the operations comprising method 1600 may be completed in any suitable order.

FIG. 17 illustrates a flow chart of an example method 1700 for receiving and decoding signals for an NFC Type A device in an electronic device having a configurable logic block. According to one example, method 1700 may begin at block 1710. Teachings of the present disclosure may be implemented in a variety of configurations of apparatus 100-600. As such, the initialization point for method 1700 and the order of 1710 comprising method 1700 may depend on the implementation chosen.

Method 1700 may begin with blocks 1610-1650 (FIG. 16) and then proceed to block 1710. At block 1710, a microprocessor in the electronic device may execute instructions to use the start signal, the data high signal, the data sample signal, and the end of data signal to process the receive data signal for the near-field communication Type A device.

Although FIG. 17 discloses a particular number of operations related to method 1700, method 1700 may be executed with greater or fewer operations than those depicted in FIG. 17. In addition, although FIG. 17 discloses a certain order of operations to be taken with respect to method 1700, the operations comprising method 1700 may be completed in any suitable order. For example, block 1710 may occur at any time after block 1610.

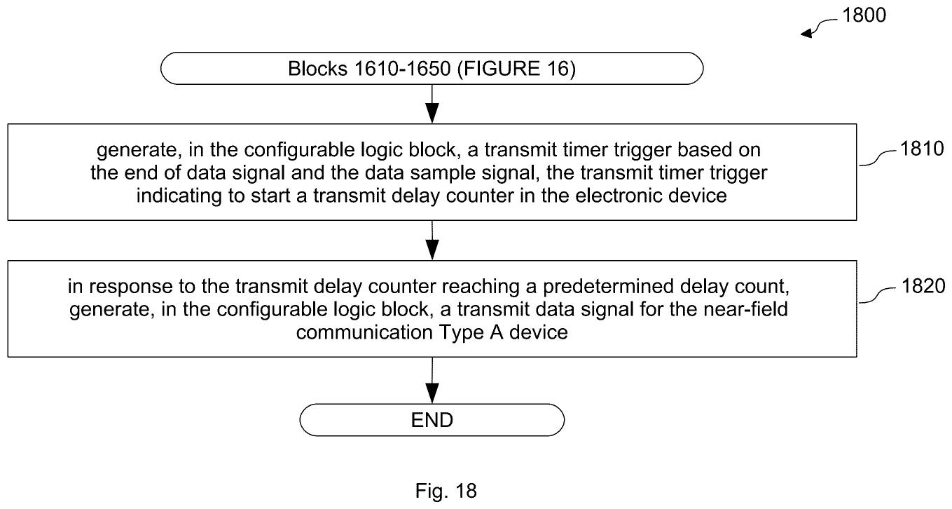

FIG. 18 illustrates a flow chart of an example method 1800 for receiving, decoding, encoding, and transmitting signals for an NFC Type A device having a configurable logic block. According to one example, method 1800 may begin at block 1810. Teachings of the present disclosure may be implemented in a variety of configurations of apparatus 100-600. As such, the initialization point for method 1800 and the order of 1810-1820 comprising method 1800 may depend on the implementation chosen.

Method 1800 may begin with blocks 1610-1650 (FIG. 16) and then proceed to block 1810. At block 1810, the configurable logic block may generate a transmit timer trigger based on the end of data signal and the data sample signal, the transmit timer trigger may indicate to start a transmit delay counter in the electronic device. At block 1820, in response to the transmit delay counter reaching a predetermined delay count, the configurable logic block may generate a transmit data signal for the near-field communication Type A device. In certain examples, the generating the transmit data signal for the near-field communication Type A device may include using a first clock, a second clock, and a data value input to generate a bit of data for the transmit data signal, the second clock having a frequency corresponding to a divided value of a first frequency of the first clock.

Although FIG. 18 discloses a particular number of operations related to method 1800, method 1800 may be executed with greater or fewer operations than those depicted in FIG. 18. In addition, although FIG. 18 discloses a certain order of operations to be taken with respect to method 1800, the operations comprising method 1800 may be completed in any suitable order.

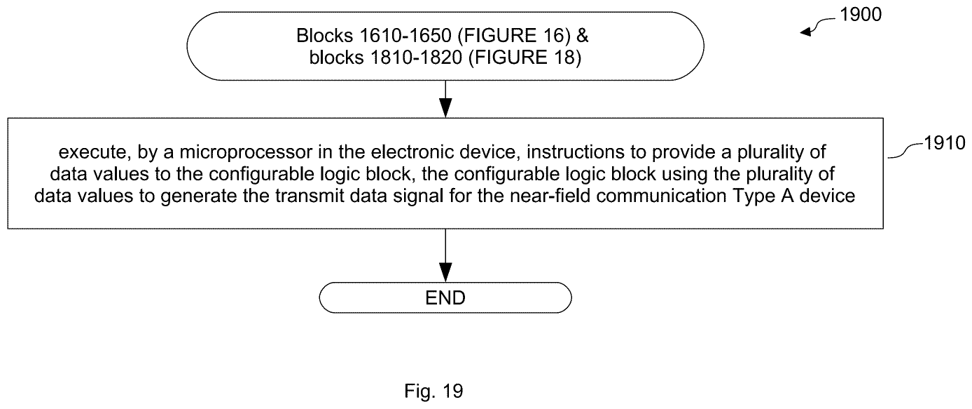

FIG. 19 illustrates a flow chart of an example method 1900 for receiving, decoding, encoding, and transmitting signals for an NFC Type A device having a configurable logic block. According to one example, method 1900 may begin at block 1910. Teachings of the present disclosure may be implemented in a variety of configurations of apparatus 100-600. As such, the initialization point for method 1900 and the order of 1910 comprising method 1900 may depend on the implementation chosen.

Method 1900 may begin with blocks 1610-1650 (FIG. 16) and blocks 1810-1820 (FIG. 18) and then proceed to block 1910. At block 1910, the microprocessor in the electronic device may execute instructions to provide a plurality of data values to the configurable logic block, the configurable logic block using the plurality of data values to generate the transmit data signal for the near-field communication Type A device.

Although FIG. 19 discloses a particular number of operations related to method 1900, method 1900 may be executed with greater or fewer operations than those depicted in FIG. 19. In addition, although FIG. 19 discloses a certain order of operations to be taken with respect to method 1900, the operations comprising method 1900 may be completed in any suitable order. For example, block 1910 may occur at any time after block 1650.

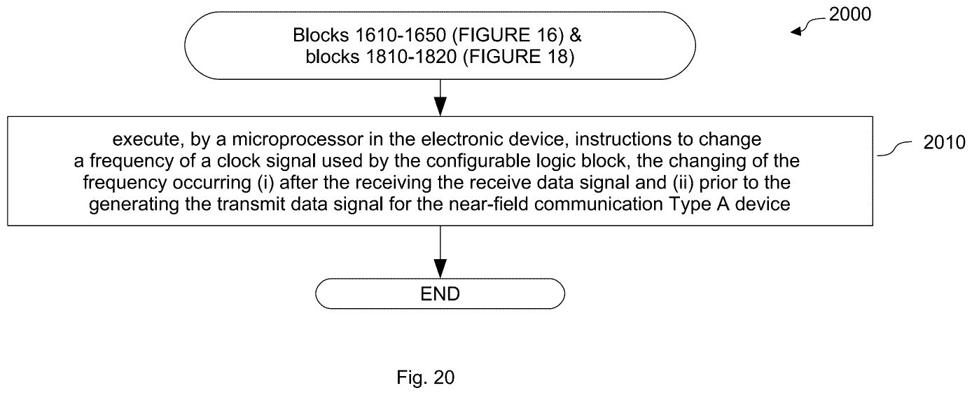

FIG. 20 illustrates a flow chart of an example method 2000 for receiving, decoding, encoding, and transmitting signals for an NFC Type A device having a configurable logic block. According to one example, method 2000 may begin at block 2010. Teachings of the present disclosure may be implemented in a variety of configurations of apparatus 100-600. As such, the initialization point for method 2000 and the order of 2010 comprising method 2000 may depend on the implementation chosen.

Method 2000 may begin with blocks 1610-1650 (FIG. 16) and blocks 1810-1820 (FIG. 18) and then proceed to block 2010. At block 2010, the microprocessor in the electronic device may execute instructions to change a frequency of a clock signal used by the configurable logic block, the changing of the frequency occurring (i) after the receiving the receive data signal and (ii) prior to the generating the transmit data signal for the near-field communication Type A device.

Although FIG. 20 discloses a particular number of operations related to method 2000, method 2000 may be executed with greater or fewer operations than those depicted in FIG. 20. In addition, although FIG. 2 discloses a certain order of operations to be taken with respect to method 2000, the operations comprising method 2000 may be completed in any suitable order. For example, block 2010 may occur at any time after block 1650.

Methods 1600-2000 may be implemented using apparatus 100-600 or any other system operable to implement methods 1600-2000. Although examples have been described above, other variations and examples may be made from this disclosure without departing from the spirit and scope of these disclosed examples

According to the present disclosure, one or more of the following benefits may be obtained:
Low R&D costs (vs. purchasing IP or developing NFC HW module)
Runs on a low power MCU (advantageous for passive NFC devices)
Uses a cheap MCU, competitive on the NFC devices market
microcontroller memory (~80% program & RAM) and peripherals are still free for the client's application
Solution is fast and accurate (using LUTs/logic gate circuit)
Associated (existing) C code is easy to plug & play and customize by client
NFC communication can also be managed automatically via interrupts
Organic growth potential
Possible future “black box” interface chips (“NFC-to-X” bridge)

Thus, systems and methods for receiving, decoding, encoding, and transmitting signals for an NFC Type A device using a CLB may be provided. Changes may be made to the present disclosure without departing from the spirit and scope of the disclosure.

1. A method, comprising:
receiving, by an electronic device having a configurable logic block, a receive data signal for a near-field communication Type A device;
generating, in the configurable logic block, a start signal indicating that a start bit has been detected in the receive data signal for the near-field communication Type A device;
generating, in the configurable logic block, a data high signal indicating that a logic high value has been detected in the receive data signal for the near-field communication Type A device;
generating, in the configurable logic block, a data sample signal indicating a sampling time for the receive data signal for the near-field communication Type A device; and
generating, in the configurable logic block, an end of data signal indicating that an end of the receive data signal has been detected.

2. The method of claim 1, comprising:
executing, by a microprocessor in the electronic device, instructions to use the start signal, the data high signal, the data sample signal, and the end of data signal to process the receive data signal for the near-field communication Type A device.

3. The method of claim 1, comprising:
generating, in the configurable logic block, a transmit timer trigger based on the end of data signal and the data sample signal, the transmit timer trigger indicating to start a transmit delay counter in the electronic device; and
in response to the transmit delay counter reaching a predetermined delay count, generating, in the configurable logic block, a transmit data signal for the near-field communication Type A device.

4. The method of claim 3, comprising:
executing, by a microprocessor in the electronic device, instructions to provide a plurality of data values to the configurable logic block, the configurable logic block using the plurality of data values to generate the transmit data signal for the near-field communication Type A device.

5. The method of claim 3, comprising:
executing, by a microprocessor in the electronic device, instructions to change a frequency of a clock signal used by the configurable logic block, the changing of the frequency occurring (i) after the receiving the receive data signal and (ii) prior to the generating the transmit data signal for the near-field communication Type A device.

6. The method of claim 3, wherein the generating the transmit data signal for the near-field communication Type A device comprises using a first clock, a second clock, and a data value input to generate a bit of data for the transmit data signal, the second clock having a frequency corresponding to a divided value of a first frequency of the first clock.

7. An apparatus, comprising:
a microprocessor; and
a configurable logic block configured to:
receive a receive data signal for a near-field communication Type A device;
generate a start signal indicating that a start bit has been detected in the receive data signal for the near-field communication Type A device;
generate a data high signal indicating that a logic high value has been detected in the receive data signal for the near-field communication Type A device;
generate a data sample signal indicating a sampling time for the receive data signal for the near-field communication Type A device; and
generate an end of data signal indicating that an end of the receive data signal has been detected.

8. The apparatus of claim 7, comprising:
instructions, executable by the microprocessor, to use the start signal, the data high signal, the data sample signal, and the end of data signal to process the receive data signal for the near-field communication Type A device.

9. The apparatus of claim 8, wherein the instructions to process the receive data signal comprise instructions, executable by the microprocessor, to:
determine that a logic one is received in the receive data signal when the data sample signal is valid and the data high signal is enabled; and
determine that a logic zero is received in the receive data signal when the data sample signal is valid and the data high signal is not enabled.

10. The apparatus of claim 7, comprising:
a transmit delay counter;
wherein the configurable logic block configured to:
generate a transmit timer trigger based on the end of data signal and the data sample signal, the transmit timer trigger causing the transmit delay counter to start; and
in response to the transmit delay counter reaching a predetermined delay count, generate a transmit data signal for the near-field communication Type A device.

11. The apparatus of claim 10, comprising:
instructions, executable by the microprocessor, to provide a plurality of data values to the configurable logic block; and
wherein the configurable logic block configured to use the plurality of data values to generate the transmit data signal for the near-field communication Type A device.

12. The apparatus of claim 10, comprising:
a first clock generator circuit configured to generate a first clock signal having a first frequency;
a second clock generator circuit configured to generate a second clock signal having a second frequency; and
instructions, executable by the microprocessor, to cause the configurable logic block to use the first clock signal when receiving the receive data signal, and to use the second clock signal when generating the transmit data signal for the near-field communication Type A device.

13. The apparatus of claim 12, wherein:
the configurable logic block configured to generate the transmit data signal for the near-field communication Type A device comprises logic configured to use the first clock signal, the second clock signal, and a data value input to generate a bit of data for the transmit data signal; and
the second frequency corresponding to a divided value of the first frequency.

14. The apparatus of claim 7, wherein the configurable logic block configured to generate the start signal comprises logic configured to detect a 1-0-1-1-1 binary pattern in the receive data signal for the near-field communication Type A device.

15. The apparatus of claim 7, wherein the configurable logic block configured to generate the data sample signal comprises logic configured to detect a 1-1-0-1 binary pattern in the receive data signal for the near-field communication Type A device.

16. The apparatus of claim 7, wherein the configurable logic block configured to generate the end of data signal comprises logic configured to detect a 1-1-1-1-1-1-1-1 binary pattern in the receive data signal for the near-field communication Type A device.

17. An apparatus, comprising:
a microprocessor;
a receive data input signal for receiving input data encoded according to a Modified Miller encoding scheme for a near-field communication Type A device;
a transmit data output signal for transmitting output data encoded according to a Manchester encoding scheme for the near-field communication Type A device;
a transmit delay counter;
a configurable logic block having an input clock signal, a plurality of sequential logic elements coupled to the input clock signal, and a plurality of combinational logic elements, wherein the plurality of sequential logic elements and the plurality of combinational logic elements operable to be configured; and
a non-volatile memory having a plurality of instructions stored therein, the plurality of instructions executable by the microprocessor to:
configure the plurality of sequential logic elements and the plurality of combinational logic elements in the configurable logic block to:
generate a start signal indicating that a start bit for the near-field communication Type A device has been detected in the receive data input signal;
generate a data high signal indicating that a logic high value for the near-field communication Type A device has been detected in the receive data input signal;
generate a data termination signal indicating that an end of transmission for the near-field communication Type A device has been detected in the receive data input signal;
generate a data sample signal indicating a sampling time for the receive data input signal;
generate a transmit timer trigger indicating to start the transmit delay counter; and
generate the encoded transmit data output signal based on a plurality of data output values; and
use the start signal, the data high signal, the data sample signal, and the data termination signal to decode the encoded receive data input signal; and
provide the configurable logic block with the plurality of data output values after the transmit delay counter reaches a predetermined delay count.

18. The apparatus of claim 17, the plurality of instructions executable by the microprocessor to change a frequency of the input clock signal of the configurable logic block.

19. The apparatus of claim 18, the plurality of instructions executable by the microprocessor to change the frequency of the input clock signal of the configurable logic block comprises instructions to:
couple the input clock signal of the configurable logic block to a first clock signal when receiving the input data on the receive data input signal; and
couple the input clock signal of the configurable logic block to a second clock signal when generating the encoded transmit data output signal.

20. The apparatus of claim 17, wherein the configurable logic block comprises a plurality of lookup tables, and wherein the configuring the plurality of sequential logic elements and the plurality of combinational logic elements in the configurable logic block uses fewer than 32 lookup tables of the plurality of lookup tables.
